(19) United States
(12) Patent Application Publication
(10) Pub. No.: US 2002/0083918 A1
(43) Pub. Date: Jul. 4, 2002

(54) Method and device for controlling an internal combustion engine

(76) Inventors: Dietbert Schoenfelder, Gerlingen (DE); Burkhard Veldten, Edemissen (DE); Ulrich Dreher, Ditzingen (DE)

Correspondence Address: KENYON & KENYON, ONE BROADWAY, NEW YORK, NY, 10004, US

(21) Appl. No.: 09/864,489

(22) Filed: May 24, 2001

(30) Foreign Application Priority Data
May 24, 2000 (DE) 100 25 669.4

(51) Int. Cl. F02B 3/00

(52) U.S. Cl. 123/299; 123/490

(57) ABSTRACT

A method and a device for controlling an internal combustion engine, having a control element for controlling the fuel injection. The fuel injection is divided into at least a first partial injection and a second partial injection. A start of triggering of the second partial injection takes place a specifiable first time span after an end of triggering of the first partial injection.

### BACKGROUND INFORMATION

A method and a device for controlling an internal combustion engine are known, for example, from German Patent No. 44 11 789. In the method described therein, the injection is divided into at least two partial injections. In that case, a control element, which is preferably designed as a solenoid valve, is used to control the fuel injection.

Because the triggering operations are close together in time, the process of opening the solenoid valve at the end of the pilot injection is influenced by the fresh triggering of the solenoid valve for the main injection. The prior to the start of the main injection should be carried out at a specific angular position of the crankshaft or camshaft, so that a favorable combustion is achieved with a view to consumption and performance.

To be able to ensure the advantages of a pilot injection, the time interval between the pilot injection and the main injection should assume a specific value. In turn, the time interval corresponds to an angle, dependent on the speed, about which the crankshaft or camshaft rotates. Due to the changing instantaneous speeds between the end of triggering of the pilot injection and the start of pump delivery of the main injection, the angle difference between the end of triggering of the pilot injection and the start of triggering of the main injection is subject to fluctuations which lead to inaccuracies in the pilot injection.

### SUMMARY OF THE INVENTION

Because a triggering of the second partial injection starts a specifiable first time span after a triggering of the first partial injection has ended, a defined connection can be attained between the end of triggering of the pilot injection and the start of pump delivery of the main injection. The instant at which the metering of fuel into the internal combustion engine begins is designated as the start of pump delivery.

It is particularly advantageous if the time span is preselected in such a way that a start of pump delivery of the second partial injection takes place a second specifiable time span after the triggering of the first partial injection has ended. This second time span is also designated in the following as delivery pause.

The method can be implemented particularly simply if the first time span is specifiable on the basis of at least one closing time of the control element, and the second time span. This means that the first time span is predefined on the basis of the desired delivery pause and the closing time of the control element which is preferably designed as a solenoid valve and/or as a piezocontroller. The closing time corresponds to the period of time between the start of triggering and the start of pump delivery.

A good adaptation to the performance characteristics of the internal combustion engine results if the second time span, i.e. the delivery pause, is specifiable as a function of at least the speed of the internal combustion engine. Further variables are also particularly advantageously taken into account.

Because a triggering duration or an end of triggering of the second partial injection is corrected on the basis of the start of pump delivery, the accuracy of the fuel metering can be improved. In particular, it is possible to compensate for errors which are based on the fact that the delivery pause is held constant.

A particularly simple correction results if the start of pump delivery is learned and is compared to a setpoint start of pump delivery, and the correction is made on the basis of the comparison.

### BRIEF DESCRIPTION OF THE DRAWINGS

FIG. 1 shows a block diagram of the device for controlling an internal combustion engine.

FIG. 2 shows various signals plotted over time.

FIG. 3 shows a block diagram of the procedure according to the present invention.

### DETAILED DESCRIPTION

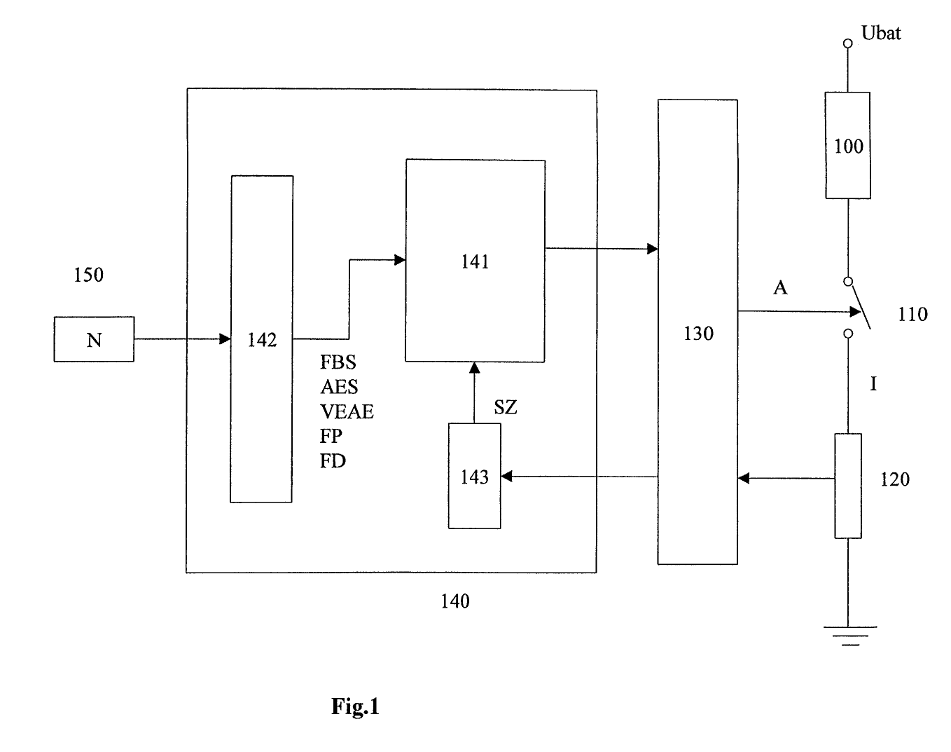

FIG. 1 shows the device for controlling an internal combustion engine as a block diagram. In the following, the procedure of the present invention is described using a distributor injection pump, controlled by a solenoid valve, as an example. At the same time, the procedure of the present invention is not restricted to this practical application; it can also be used when working with other fuel-metering devices controlled by solenoid valves. Moreover, instead of a solenoid valve, other control elements such as, in particular, piezoactuators can also be used.

A control element is designated by 100. It is connected first of all to a supply voltage Ubat, and secondly to a switching element 110. Switching element 110 is furthermore connected to a grounded connection via a current-measuring means 120. The order of control element 100, switching element 110 and current-measuring means 120 is selected only by way of example. Other sequences of this series circuit can also be provided. Moreover, it is possible to use further switching elements for triggering control element 100. The representation in FIG. 1 is only one exemplary representation.

Switching element 110 receives trigger signals A from a driver stage (output stage) 130. Current-measuring means 120, preferably constructed as a resistor, supplies to the driver stage a signal which characterizes current I flowing through the control element. Driver stage 130 acts upon a control unit 140 with signals, and receives trigger signals from control unit 140.

Control unit 140 essentially includes an on/off switching control 141, an injection control 142 and a switching-time determination 143. Various signals which characterize the operating state of the internal combustion engine and/or conditions of the surroundings are supplied to control unit 140 from sensors 150. In this context, one essential variable is speed N of the internal combustion engine.

The sensor signals reach injection control 142 which, based on these and other data, defines different variables that characterize, for example, the setpoint value for the start of pump delivery FBS, the setpoint value for the end of triggering of the main injection AES, the end of triggering for the pilot injection VEAE, the delivery pause FP and the delivery duration of the main injection FD, to on/off switching control 141.

Based on these variables and further variables such as switching time SZ, which is supplied by switching-time determination 143, on/off switching control 141 determines signals for acting upon driver stage 130. They are, inter-alia, a signal AB which characterizes the start of triggering of the main injection, and a signal AE which characterizes the end of the main injection. In this context, the on/off switching control supplies signals which characterize the start of triggering and the end of triggering of the pilot injection.

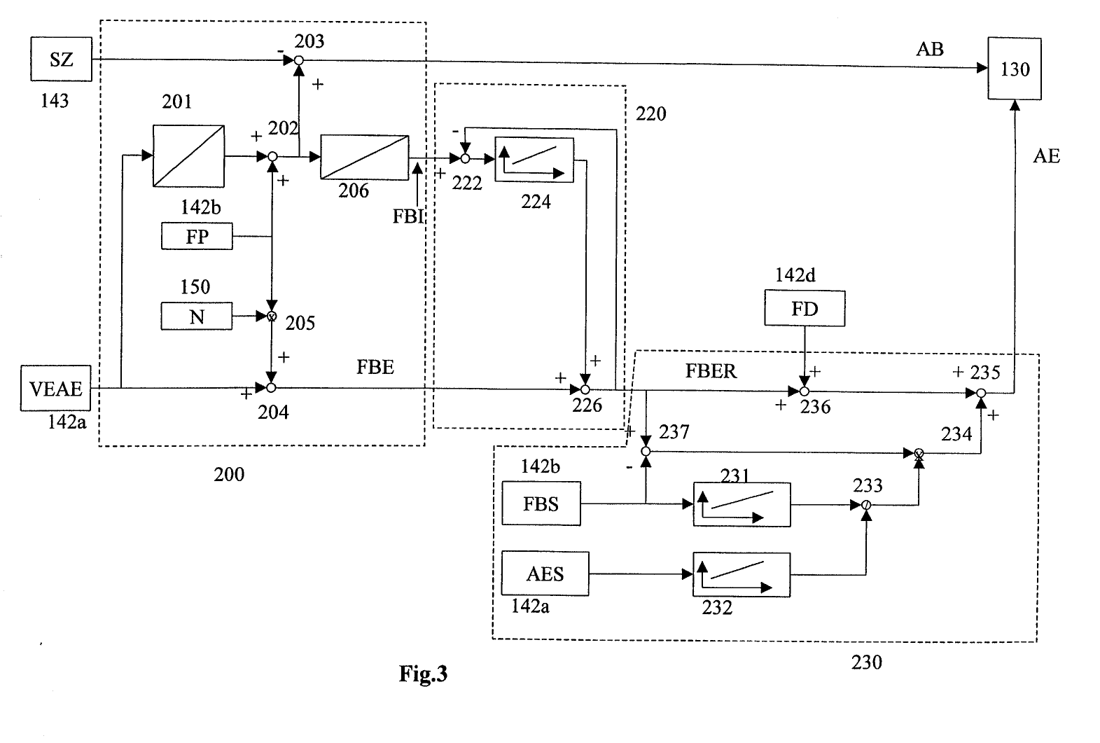

On/off switching control 141 is shown in detail in FIG. 3. The calculation of the different variables in injection control 142 can be carried out in various ways, and is not described in greater detail in the following.

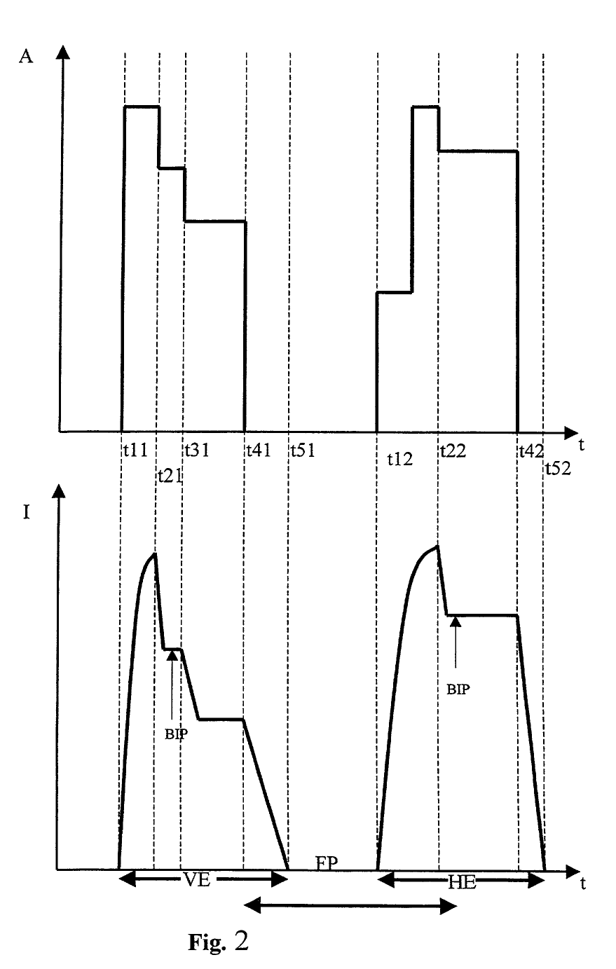

In FIG. 2, trigger signal A for acting upon switching element 110, and current I which flows through control element 100, are plotted over time t. FIG. 2 shows an injection process in which the injection is divided into at least two partial injections. The first partial injection is designated as pilot injection VE, and the second partial injection is designated as main injection HE. Usually the pilot injection is used for reducing noise emissions. This objective of the pilot injection can only be achieved if the two partial injections are in a specific time relationship to one another.

The procedure of the present invention is not restricted to the use for a division into a pilot injection and a main injection. The procedure can be used for all injection systems in which at least two partial injections are provided. Thus, more than two partial injections can also be provided.

As of instant t11, signal A assumes a very high level, i.e. the current flow through control element 100 is released. This means that current I increases very rapidly to a very high value.

At instant t21, trigger signal A is reduced and the current is regulated back to an average level. At instant t31, the trigger signal is reduced still further and the current falls to a holding current. At instant t41, the trigger signal is reduced to 0, and the current falls up to instant t51 to 0.

The injection ends at instant t51. The injection process between instants t11 and t51 is also designated as pilot injection. In a simplified embodiment, the current level, and therefore trigger signal A as well, can assume a constant value between instants t21 and t41, and not drop to a lower value.

Main injection HE begins at instant t12, i.e. the trigger signal increases again to the high value, and the current increases to its high value. At instant t22, the trigger signal is reduced, and the current falls to the holding current. At instant t42, the trigger signal is reduced, and the current falls up to instant t52 to 0.

The instant at which the control element takes its new position, that is to say, in this exemplary embodiment, the injection begins, is designated by BIP and a vertical arrow. The injection begins at this instant. This instant is also called the start of pump delivery.

The period of time of pilot injection VE and of main injection HE is designated by a double arrow. Delivery pause FP between instant t41, which corresponds to the end of triggering of the pilot injection, and the instant at which the main injection begins is also marked in.

On/off switching control 141 is shown in detail in FIG. 3. This on/off switching control 141 essentially includes a calculation 200 of the triggering and the start of pump delivery, a start-of-pump-delivery observer 220, as well as a triggering-duration correction 230. Based on switching time SZ, which is provided by switching-time determination 143, and the end of triggering of pilot injection VEAE, which is provided by injection control 142, triggering/delivery-duration calculation 200 determines a signal AB, which establishes the start of triggering of the main injection, an interpolated start of pump delivery FBI, as well as an extrapolated start of pump delivery FBE.

The extrapolated and the interpolated starts of pump delivery are supplied to start-of-pump-delivery observer 220. Start of triggering AB is supplied to driver stage 130. In addition, triggering/start-of-pump-delivery calculation 200 processes a signal FP regarding the delivery pause, which is provided by injection control 142, and a speed signal N from speed sensor 150.

End of triggering VEAE of the pilot injection arrives with a positive operational sign at a node 204 and at an angle/time conversion 201. Delivery pause FP arrives with a positive operational sign via a node 205 at the second input of node 204. Speed N is applied at the second input of node 205. The two quantities are combined, preferably multiplicatively, in node 205.

Furthermore, delivery pause FP is applied, with a positive operational sign, at the input of a node 202, at whose second input the output signal of angle/time calculation 201 is applied with a positive operational sign. The output signal of node 202 acts first of all on a time/angle conversion 206, and secondly, with a positive operational sign, on node 203. Interpolated start of pump delivery FBI is present at the output of time/angle conversion 206. Extrapolated start of pump delivery FBE is present at the output of node 204.

Switching time SZ is applied, with a negative operational sign, at the second input of node 203. Start of triggering AB is present at the output of node 203.

Extrapolated start of pump delivery FBE arrives with a positive operational sign at a node 226 whose output signal arrives with a negative operational sign at a node 222. Interpolated start of pump delivery FBI is applied, with a positive operational sign, at the second input of node 222. A controller 224 receives the output signal of node 222. Controller 224 gives a signal with a positive operational sign to node 226. Present at the output of node 226 is an expected start of pump delivery FBER which is routed to triggering correction 230.

Controller 224, as well as nodes 222 and 226 form the start-of-pump-delivery observer.

The elements of the triggering-duration correction are described in the following. Expected start of pump delivery FBER arrives with a positive operational sign at a node 237 and at a node 236. Delivery duration FD, which is likewise provided by injection control 142, is applied at the second input of node 236. The output signal of node 236 arrives with a positive operational sign at a node 235. End of triggering AE is present at the output of node 235.

Start-of-pump-delivery setpoint value FBS is applied, with a negative operational sign, at the second input of node 237. It also arrives at a node 233 via a program map 231. The end-of-triggering setpoint value likewise arrives at node 233 via a program map 322. An output signal of node 233 reaches the second input of a node 234, at whose first input the output signal of node 237 is applied. The second input of node 235 receives the output signal of node 234 with a positive operational sign.

In order to attain a time-defined connection between end of triggering VEAE of the pilot injection and start of triggering AB of the main injection, a delivery pause FP is predefined which is dependent at least on speed N. The delivery pause corresponds to the time interval between end of triggering VEAE of the pilot injection and start of pump delivery FB of the main injection.

In order to achieve this, end of triggering VEAE of the pilot injection is converted by the angle/time conversion into an instant. At this instant, delivery pause FP is added as a time variable in node 202. This instant is subsequently converted again into an angle size (variable) by time/angle conversion 206. This angle size is also designated as interpolated start of pump delivery FBI. Thus, the start of pump delivery takes place a specifiable time span after the end of triggering of the pilot injection.

In node 203, switching time SZ is subtracted from the instant of start of pump delivery FBI, and thus start of triggering AB is calculated. This procedure ensures the accuracy of the pilot injection quantity. That is to say, the interval between the start of the main injection and the end of the pilot injection is set at a specific value, independently of the speed. This means that the interval between the start of triggering of the main injection and the end of triggering of the pilot injection is specifiable on the basis of the specifiable time span, i.e. the delivery pause, and the closing time of the control element.

The error arising concerning the start of pump delivery is learned via a start-of-pump-delivery observer 220, and is subsequently taken into account by triggering-duration correction 230 when determining end of triggering AE.

The difference in the start of pump delivery between setpoint start of pump delivery FBS and expected start of pump delivery FBER is added on at the end of triggering, that is to say, the triggering duration is prolonged by this amount. Start-of-pump-delivery observer 220 compares expected start of pump delivery FBER with interpolated start of pump delivery FBI, and with the aid of controller 224, determines a correction value for correcting extrapolated start of pump delivery FBE based on this comparison. Extrapolated start of pump delivery FBE, corrected by this correction value, is used as expected start of pump delivery FBER. End of triggering AE is yielded by the addition of expected start of pump delivery FBER and delivery duration FD.

Since the quantity delivered per unit of time is different because of the different cam inclination at the end of triggering and at the start of pump delivery, an appropriate correction of this influence is made in blocks 231 and 232. This means that correction values, by which the triggering duration is corrected, are stored in program maps 231 and 232, in order to correct the above effect.

What is claimed is:

1. A method for controlling an internal combustion engine, comprising:
controlling a fuel injection using a control element, the fuel injection being divided into at least a first partial injection and a second partial injection, a start of triggering of the second partial injection taking place a preselected first time period after an end of triggering of the first partial injection.

2. The method according to claim 1, wherein the first time period is preselected such that a start of pump delivery of the second partial injection takes place a preselected second time period after the end of triggering of the first partial injection.

3. The method according to claim 2, wherein the first time period is a function of at least one closing time of the control element and the second time period.

4. The method according to claim 2, wherein the second time period is a function of at least a speed.

5. The method according to claim 2, further comprising correcting at least one of a triggering duration and an end of triggering of the second partial injection as a function of the start of pump delivery.

6. The method according to claim 5, wherein the correction includes the following:
learning the start of pump delivery;
comparing the learned start of pump delivery to a setpoint start of pump delivery; and
performing the correction as a function of the comparison.

7. A device for controlling an internal combustion engine comprising:
a control element for controlling a fuel injection, the fuel injection being divided into at least a first partial injection and a second partial injection; and
means for causing a triggering of the second partial injection to start a preselected time period after a triggering of the first partial injection has ended.
